(19) United States
(12) Patent Application Publication
(10) Pub. No.: US 2006/0092278 A1
(43) Pub. Date: May 4, 2006

(54) Imaging device and method for vehicles

(75) Inventors: Akihiro Kondo, Okazaki-city (JP); Hiroaki Ito, Aichi-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/264,388

(22) Filed: Nov. 2, 2005

(30) Foreign Application Priority Data
Nov. 2, 2004 (JP) 2004-319741

(51) Int. Cl. H04N 7/18; H04N 9/47

(52) U.S. Cl. 348/152; 348/143; 348/148

(57) ABSTRACT

When an approach sensor detects approach of a human body to a vehicle, an imaging device for vehicles brings an imaging system power supply for an image recording camera into ON state. When an intrusion detection sensor detects intrusion of a human body into the vehicle, the imaging device generates an image pickup trigger signal. It thereby switches the image recording camera and an image processing section from a sleep state which is a low-power consumption state, to a wake-up state, which lasts for a first predetermined time. When brought into the wake-up state, the image recording camera picks up an image.

### CROSS REFERENCE TO RELATED APPLICATION

This application is based on and incorporates herein by reference Japanese Patent Application No. 2004-319741 filed on Nov. 2, 2005.

### TECHNICAL FIELD

The present invention relates to an imaging device and an imaging method for vehicles that are effective when a suspicious individual or the like intrudes into a vehicle.

### BACKGROUND ART

Conventionally, a vehicle parking in a parking lot or on a street may be thieved or something may be stolen from the inside of such a vehicle by a suspicious individual.

To cope with this, JP2001-338378A proposes an interior intrusion notifying, imaging and recording device for vehicles. The device includes: a sensor that detects intrusion of a suspicious individual into a vehicle compartment; an imaging device installed in a predetermined position in the vehicle compartment; a radio telephone control device that is connected with radio telephone equipment and causes it to carry out communicating operation; a voice response device that outputs a voice message for notification of intrusion into car interior; a picture storage device that is fed with a video signal outputted from the imaging device and stores it; a screen display device that displays the image corresponding to a stored video signal; and an owner switch that is operated to do input indicating that an intruder is the owner of the relevant vehicle.

This device operates as follows when the sensor outputs a detection signal and the owner switch is not turned on within a predetermined time from the time of output of the detection signal: imaging operation of the imaging device is started, and storage of the video signal outputted from the imaging device is started; at the same time, a call is originated to the destination of notification at a number entered beforehand in the radio telephone equipment; when there is a response from the destination of notification at the number, a voice message is outputted and transmitted to the destination of notification at the number through the radio telephone equipment.

In a case where an imaging device, such as a camera, or the like is mounted in a vehicle, as described above, power for the device is supplied from a battery. Imaging devices and image processing circuits consume a large current. To keep watch against intrusion and theft, however, they must be supplied with power and operated when the vehicle is parked. When a vehicle is parked for a long time, a large amount of power is consumed by the operation of the imaging device and the like, which may lead to running out of the battery.

To cope with this, JP2002-308054A proposes a device that includes: a camera ECU that processes the data of an image picked up with a camera; a main control section (gateway device, security ECU) that carries out predetermined processing based on the contents of image data; and an imaging system power supply path for supplying power to the camera and the camera ECU through an ACC relay. The device is so constructed that when intrusion of a suspicious individual into the vehicle is detected, the main control section switches the imaging system power supply path from OFF state to ON state. With this device, power is not supplied to the camera or the camera ECU unless intrusion of a suspicious individual is detected. Therefore, the consumption current can be reduced, and the load on a battery is reduced and the battery can be prevented from running out. Since imaging devices, such as cameras, are of auto gain control, however, a delay of a certain time (1 to 2 seconds) is required from when power supply is started to when they get ready for imaging. Therefore, with a method in which an imaging system power supply path is turned on when a suspicious individual intrudes into a vehicle, the appropriate opportunity to shoot will be missed.

### SUMMARY

An object of the present invention is to provide an imaging device for vehicles that operates with a low consumption current and is capable of picking up an image with appropriate shooting timing and an imaging method therefor.

The imaging device and method for vehicles are so constructed that the following operation is performed: when approach of a human body to a vehicle is detected, the imaging system power supply is turned on. When the imaging system power supply is turned on and intrusion of a human body into the vehicle is detected, an image recording device and an image processing section are transitioned from a sleep state, or low-consumption current state, to a wake-up state, which lasts for a first predetermined time. As a result, when the image recording device is transitioned form the sleep state to the wake-up state, which lasts for the predetermined time, the imaging system power supply has been already in ON state. Thus, when a human body intrudes into the vehicle, its image can be picked up with appropriate shooting timing without delay.

When it is determined that conditions for turning on the imaging system power supply have been met, a main control section switches the state of the imaging system power supply from the OFF state to the ON state. At the same time, the main control section outputs an image pickup trigger signal to bring the image recording device and the image processing section into wake-up state, which lasts for a second predetermined time. With the above-described construction, the image recording device is brought into the wake-up state and enabled to pick up an image when a human body approaches the vehicle as well as when a human body intrudes into the vehicle.

When it is detected that processing by the image processing section has terminated, the main control section brings the image recording device and the image processing section into the sleep state. The image processing section includes a video decoder that converts a signal (analog signal) from the image recording device into a digital signal so that the signal can be used in the main control section and the like. The video decoder is large in consumption current. Therefore, the consumption current of this imaging device for vehicles can be further reduced by taking the following procedure: the video decoder is operated only when an image is picked up (an image is processed), and the operation of the video decoder is stopped when imaging (image processing) terminates. Also, heat produced by the video decoder can be reduced, and the operating temperature specifications for components can be lowered even in strict operating ambient temperature conditions for the in-vehicle environment.

A bus buffer is provided which connects and disconnects signal lines through which image data is transmitted from the image processing section to the main control section. When it is detected that processing by the image processing section has terminated, the main control section causes the bus buffer to disconnect the signal lines. In general, the signal lines through which image data is transmitted from the image processing section to the main control section are designated as data buses. When power is supplied to the main control section and is not supplied to the image processing section, the following can take place depending on the circuit configuration of the image processing section: a current flows from the main control section to the image processing section through the data buses, and this destroys the circuit elements of the image processing section. With the above-described construction, the data buses are brought into high impedance state by the bus buffer electrically blocking the signal lines (data buses). As a result, a current does not flow from the main control section to the image processing section, and the circuit elements of the image processing section can be protected.

### BRIEF DESCRIPTION OF THE DRAWINGS

FIG. 1 is a circuit diagram illustrating an imaging device for vehicles in an embodiment;

FIG. 2 is a timing diagram for explaining the processing to control an imaging system power supply;

FIG. 3 is a circuit diagram of a bus buffer and its periphery;

FIG. 4 is a timing diagram for explaining the processing to control an imaging system power supply using a bus buffer;

FIG. 5 is a flowchart illustrating a modification to a first embodiment; and

FIG. 6 is a circuit diagram illustrating a video recorder.

### DETAILED DESCRIPTION OF EXEMPLARY EMBODIMENTS

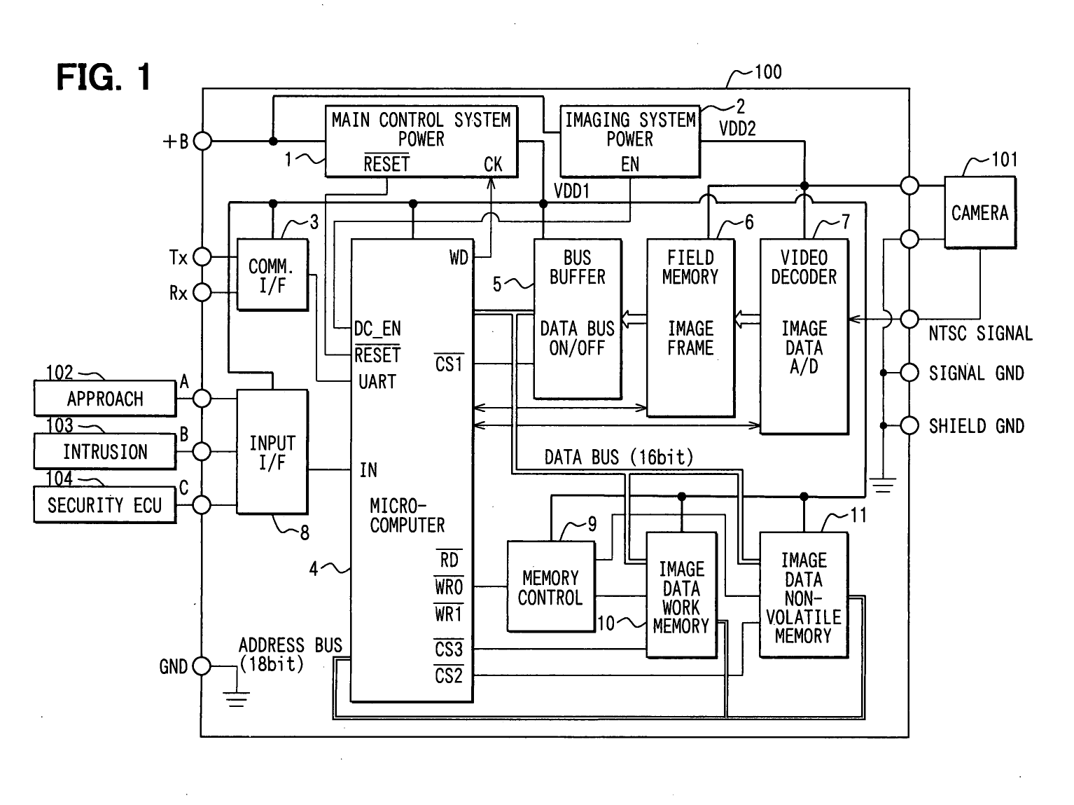

As illustrated in FIG. 1, an imaging device 100 includes: a main control system power supply 1; an imaging system power supply 2; a communication I/F (InterFace) 3; a microcomputer 4; a bus buffer 5; a field memory 6; a video decoder 7; an input I/F 8; a memory control unit 9; an image data work memory 10;. and an image data nonvolatile memory 11.

The communication I/F 3, microcomputer 4, bus buffer 5, memory control unit 9, image data work memory 10, and image data nonvolatile memory 11 are included in a main control section. The field memory 6 and the video decoder 7 are included in an image processing section.

The imaging device 100 also includes: communication module terminals Tx and Rx for communication with external equipment, including the transmission of image data; sensor signal terminals A and B; a theft detection signal input terminal C; a camera power supply terminal for supplying power to a camera 101 and an auxiliary light source; an NTSC terminal for inputting a video signal from the camera 101.

The main control system power supply 1 converts voltage (+B) from a battery, not shown, into predetermined voltage (VDD1), and supplies it to the communication I/F 3, microcomputer 4, bus buffer 5, input I/F 8, memory control unit 9, image data work memory 10, and image data nonvolatile memory 11. Also, the main control system power supply 1 monitors the operation of the microcomputer 4. More specific description will be given. The microcomputer 4 outputs a pulse signal of a predetermined period through WD terminal, and the main control system power supply 1 receives that pulse signal through CK terminal.

When the leading edge or the trailing edge of that pulse signal is detected, the main control system power supply 1 clears a counter to zero. When the count on the counter exceeds a predetermined value (that pulse signal is not received within a predetermined time), the operation of the microcomputer 4 is determined to be anomalous. Then, the main control system power supply transmits a reset signal to the RESET terminal of the microcomputer 4 through its RESET terminal to reset the microcomputer 4.

Though the terminals with an over bar symbol added above their terminal names in FIG. 1 operate in the negative logic (active low), they will be represented without over bar symbol in the description of this embodiment.

The imaging system power supply 2 converts voltage (+B) from a battery, not shown, into predetermined voltage (VDD2), and supplies it to the field memory 6, video decoder 7, camera 101, and auxiliary light source for camera (through the camera power supply terminal). The imaging system power supply 2 takes in a control signal, outputted from the microcomputer 4 through DC_EN terminal, through its EN terminal, and it supplies voltage or interrupts the supply thereof based on the contents of that control signal.

The communication I/F 3 is a circuit that carries out communication between the microcomputer 4 and external equipment, and takes a circuit configuration corresponding to the communication standard for connected external equipment. Possible external equipment includes in-vehicle equipment connected to an in-vehicle LAN (Local Area Network) and communication equipment that communicates with sources external to the vehicle.

The microcomputer 4 carries out main control, determines whether conditions are met, and detects the termination of image processing, and includes well-known CPU, ROM, RAM, and the like, not shown. The microcomputer 4 is so constructed that the CPU carries out control according to a control program and data stored in the ROM or the RAM.

The bus buffer 5 connects (ON) or disconnects (OFF) the data transmission lines (data buses) between the field memory 6 and the microcomputer 4. It operates according to a command from the microcomputer 4 (a control signal supplied through CS1).

The video decoder 7 converts a video signal (NTSC signal: analog signal) transmitted from the camera 101 into image data. For the video decoder 7, a publicly known decoder LSI, such as MSM7664TB from Oki Electric Industry Co., Ltd., is used. This video recorder 7 A-D converts a composite signal contained in an inputted NTSC signal to obtain digital image data composed of RGB (Red Green Blue) signals. (The composite signal is a composite video signal obtained by combining a video signal, a burst, and a composite synchronizing signal.) With this construction, digital image data is generated at a rate of 60 frames per second.

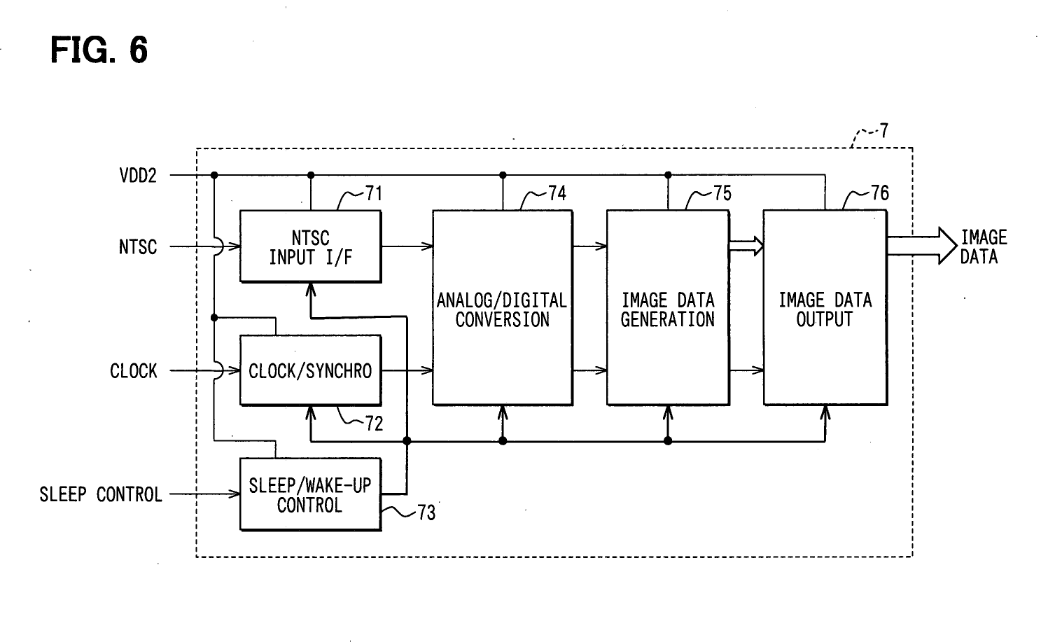

As illustrated in FIG. 6, the video recorder 7 includes: an NTSC input I/F circuit 71; a clock/synchronizing signal circuit 72; a sleep/wake-up control circuit 73; an analog/digital conversion circuit 74; a digital image data generation circuit 75; and an image data output circuit 76. When the microcomputer 4 turns on DC_EN terminal, voltage VDD2 is supplied from the imaging system power supply 2 to the individual circuits 71 to 76. The sleep/wake-up control circuit 73 has a sleep control signal inputted from the microcomputer 4.

When the microcomputer 4 brings the sleep control signal into the High level, the sleep/wake-up control circuit 73 detects that and outputs a control signal. The control circuit thereby brings the circuits 71, 72, 74, 75, and 76 into the sleep state, or low-power consumption mode. When the microcomputer 4 brings the sleep control signal into the Low level, the sleep/wake-up control circuit 73 brings the circuits 71, 72, 74, 75, and 76 into wake-up state. In wake-up state, the circuits 74 to 76 operate in synchronization with a clock signal outputted from the clock/synchronizing signal circuit 72. In sleep state, the actual operation is stopped, though voltage VDD2 is supplied. The consumption current of the video recorder 7 is approximately 10 mA in the sleep state and approximately 150 mA in the wake-up state.

The field memory 6 is FIFO (First In/First Out) memory, and accumulates digital image data, generated by the video decoder 7, one frame by one frame until it is read out by the microcomputer 4.

The input I/F 8 takes in signals through the sensor signal terminals A and B and the theft detection signal terminal C, and adjusts the voltage level and the like so that the signals can be processed by the microcomputer 4.

The memory control unit 9 reads or writes image data from or to either the image data work memory 10 or the image data nonvolatile memory 11 according to commands from the microcomputer 4 (control signals supplied through RD, WR0, WR1, CS3, and CS2).

The image data work memory 10 is a work area for temporarily holding digital image data taken in from the field memory 6 by the microcomputer 4. To reduce the load on the microcomputer 4, a DMA (Direct Memory Access) method is used to transfer digital image data from the microcomputer 4.

The image data nonvolatile memory 11 is constructed of a memory, such as a flash memory, capable of storing and holding the contents of data even after power supply to the imaging device 100 for vehicles is turned off. It converts digital image data taken in from the image data work memory 10 into image data in a predetermined image format, such as JPEG (Joint Photographic Experts Group).

The sensor signal terminal A is for taking in a signal from an approach sensor 102 that detects approach to the vehicle. Various types of sensors, including those that use ultrasonic waves to detect approach to the vehicle and those that use radio waves to detect approach to the vehicle, can be used for the approach sensor 102.

The sensor signal terminal B is for taking in a signal from an intrusion sensor 103 that detects intrusion into the vehicle. Various types of sensors, including those that detect the inclination of a vehicle and those that detect breaking glass, can be used for the intrusion sensor 103. (Sensors that detect the inclination of a vehicle are capable of detecting theft by towing with a wrecking car or theft by loading onto another vehicle.)

There is no special restriction imposed on the number of sensor signal terminals and the functions of sensors as long as they are capable of detecting approach to and intrusion into a vehicle.

The theft detection signal terminal C takes in a theft detection signal transmitted from a security ECU 104. When it is detected that a door or a trunk lid has been broken open, for example, the security ECU 104 gives an alarm. The alarm is given by the operation of blowing the horn of the vehicle, causing the hazard flasher to blink, or the like. In this embodiment, a horn blowing command signal outputted from the security ECU 104 is taken in as the theft detection signal.

The basic functions of this imaging device 100 are as follows: when a theft detection signal is detected, an analog video signal from the camera 101 is converted into digital in the video decoder 7 to obtain image data. Then, this image data is stored in the image data nonvolatile memory 11. The stored image data is transmitted to a management center external to the vehicle, the owner of the vehicle, or the like through the communication I/F 3 and the communication module terminals Tx and Rx. Thus, the image data is used as evidence of a case of theft to facilitate the arrest of a criminal. Alternatively, a vehicle is monitored with the camera 101 to prevent vehicle theft. Image data that has been already transmitted is deleted one by one.

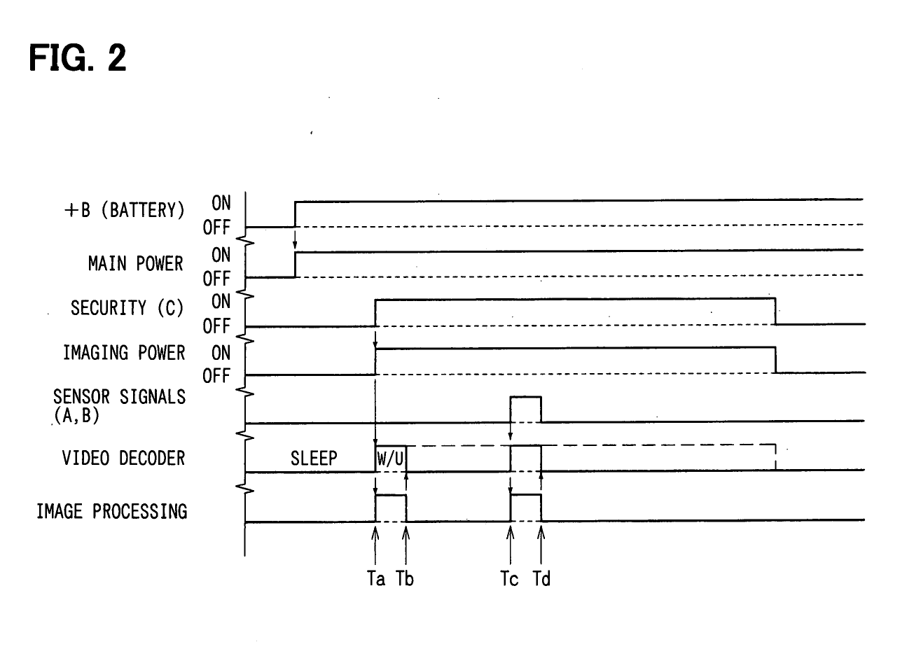

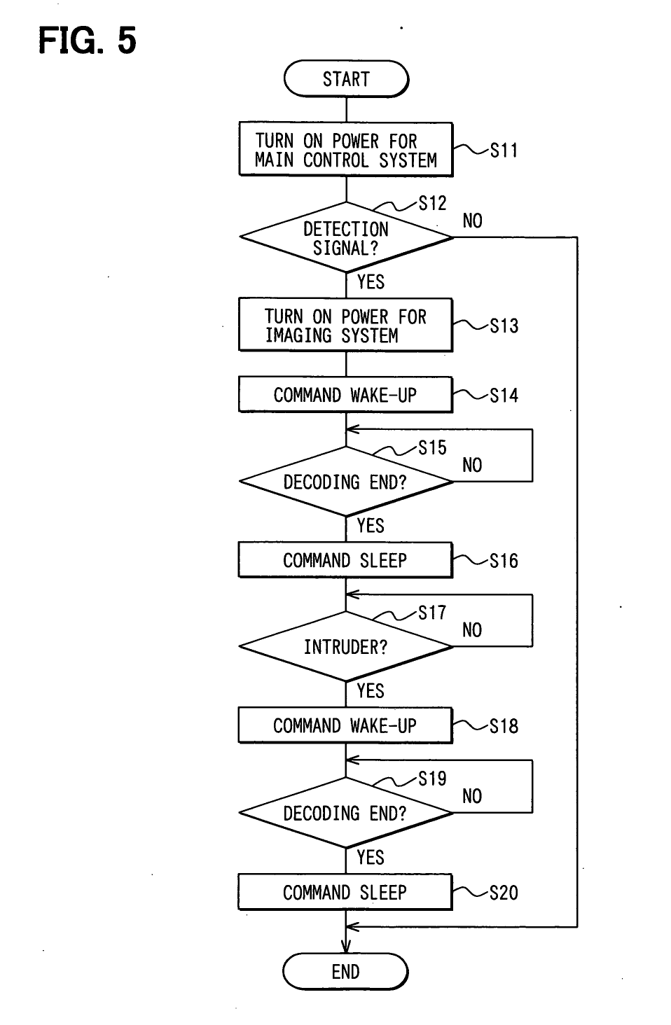

The processing to control the imaging system power supply 2, carried out by the microcomputer 4, will be described with reference to the timing diagram in FIG. 2 and the flowchart in FIG. 5. This processing is contained in the control program stored in the ROM or the RAM of the microcomputer 4, and is repeatedly performed together with other processes.

When power is supplied from a battery, not shown, the main control system power supply 1 is turned on, and voltage VDD1 is supplied to the following: the communication I/F (InterFace) 3, microcomputer 4, bus buffer 5, input I/F 8, memory control unit 9, image data work memory 10, and image data nonvolatile memory 11 (Step S11).

When a theft detection signal, transmitted from the security ECU 104 through the theft detection signal terminal C, is detected, the microcomputer 4 turns on the DC_EN terminal so as to turn on the imaging system power supply 2 (OFF state→ON state). This operation is also performed when the approach sensor 102 detects approach of the human body of a suspicious individual or the like (S12: Yes). Thus, voltage VDD2 is supplied from the imaging system power supply 2 to the field memory 6, video decoder 7, camera 101, and auxiliary light source for the camera 101 (S13). The microcomputer 4 transmits to the video decoder 7 a command (image pickup trigger signal) to start decoding. The video decoder 7 is brought into the wake-up state, which lasts for a predetermined time, and starts decoding (at time Ta in FIG. 2, S14 in FIG. 5).

Video signals from the camera 101 are converted into digital image data for a predetermined time (i.e., by a predetermined number of images). When this decoding is thus terminated (S15: Yes), the video decoder 7 transmits a decode end notice to the microcomputer 4. When the microcomputer 4 receives the decode end notice, it transmits a command to the video decoder 7 to bring the video decoder 7 into the sleep state (at time Tb in FIG. 2, S16 in FIG. 5).

When the intrusion sensor 103 thereafter detects the intrusion of a human body (OFF state→ON state) (S17: Yes), the microcomputer 4 transmits to the video decoder 7 a command (image pickup trigger signal) to start decoding. The video decoder 7 is brought into the wake-up state (at time Tc in FIG. 2, S18 in FIG. 5), which lasts for a predetermined time. The duration for which the wake-up state is kept established at this time is shorter than the duration of the wake-up state established at S14. More specifically, at S14, the wake-up state is established immediately after the imaging system power supply 2 is turned on. Therefore, a delay time between when power to the camera 101 and the video recorder 7 is turned on and when the operation is stabilized is allowed for when the duration for which the wake-up state should be kept established is set. At S18, meanwhile, a sufficient time has passed after the imaging system power supply 2 was turned on, and the operation of the camera 101 and the video recorder 7 has been already stabilized. Therefore, the duration for which the wake-up state should be kept established can be shortened.

Video signals from the camera 101 are converted into digital image data for a predetermined time (i.e., by a predetermined number of images). When this decoding is thus terminated (S19: Yes), the video decoder 7 transmits a decode end notice to the microcomputer 4. When the microcomputer 4 receives the decode end notice, it transmits a command to the video decoder 7 to bring the video decoder 7 into sleep state (at time Td in FIG. 2, S20 in FIG. 5).

When a theft detection signal from the security ECU 104 is not detected any more (ON state→OFF state) during the processing from S13 to S20, the microcomputer 4 turns off the DC_EN terminal. As a result, the supply of voltage VDD2 from the imaging system power supply 2 to the field memory 6, video decoder 7, camera 101, and auxiliary light source for the camera 101 is stopped. This control processing is also terminated. The following operation may be performed: when the video decoder 7 is brought into sleep state at S16, the imaging system power supply 2 is turned off; when intrusion is detected at S17, the imaging system power supply 2 is turned on.

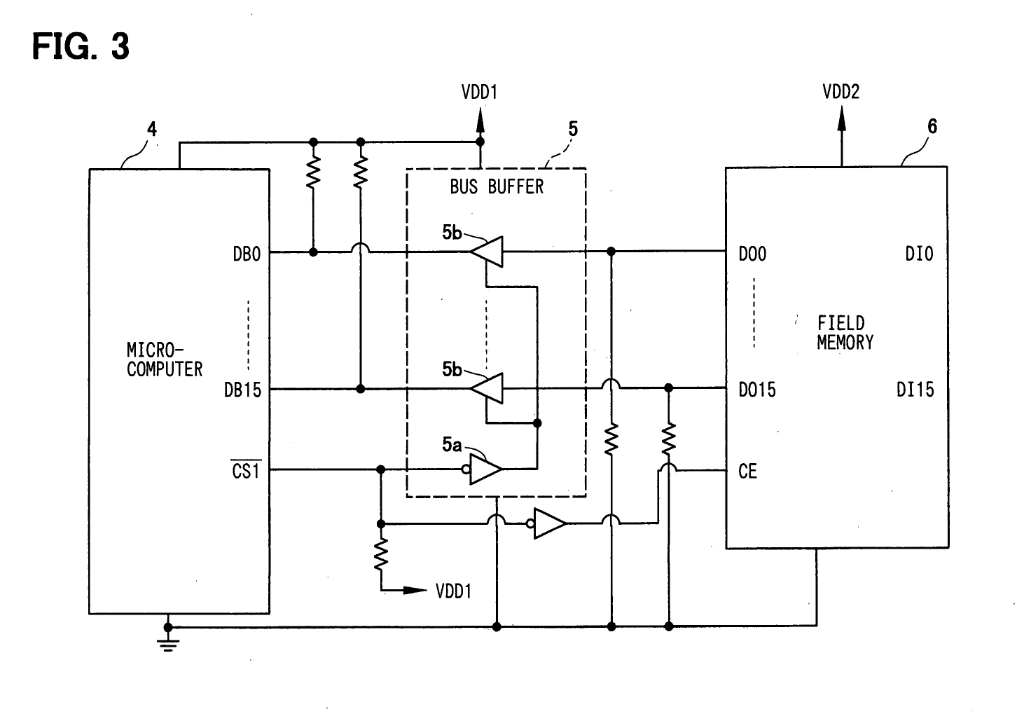

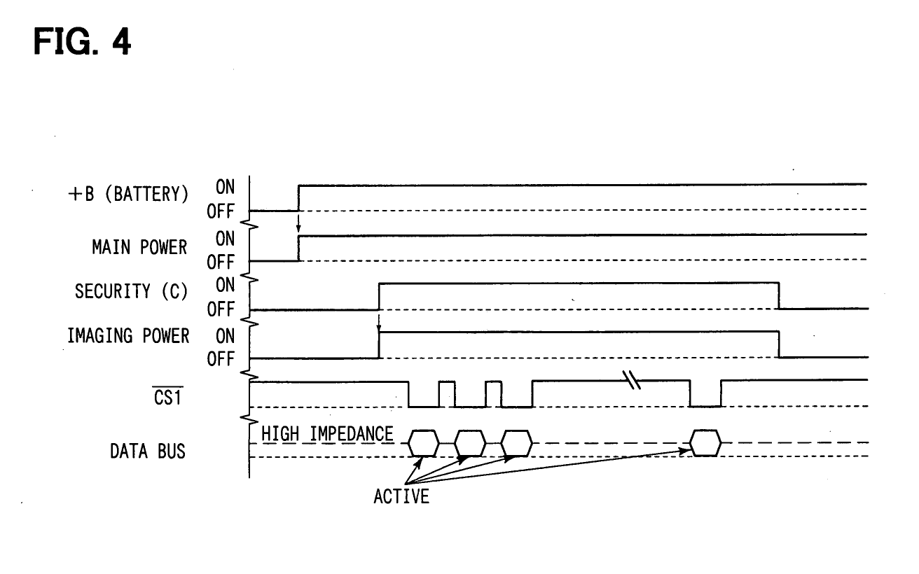

The operation of the bus buffer 5 will be described with reference to FIG. 3 and FIG. 4. The bus buffer 5 is so constructed that: bus buffer circuits 5b (e.g., 16 pieces) are placed (in the data buses) between the data bus terminals (DB0 to DB15) of the microcomputer 4 and the data bus terminals (DO0 to DO15) of the field memory 6. The data buses are connected or disconnected by a common gate control circuit 5a.

In FIG. 4, when a theft detection signal, transmitted from the security ECU 104 through the theft detection signal terminal C, is detected (OFF state→ON state), the microcomputer 4 turns on the DC_EN terminal so as to turn on the imaging system power supply 2. This operation is also performed when the approach sensor 102 detects approach of a human body. Thus, voltage VDD2 is supplied from the imaging system power supply 2 to the field memory 6, video decoder 7, camera 101, and auxiliary light source for the camera 101. The microcomputer 4 transmits a command to start decoding to the video decoder 7, and the video decoder 7 is brought into wake-up state and starts decoding.

The microcomputer 4 determines whether there is digital image data in the field memory 6. In a case where there is digital image data, the microcomputer reads that digital image data, and writes it into the image data work memory 10.

When an L-level signal (0V) is outputted from the microcomputer 4 through its CS (Chip Select) 1 terminal at this time, the gate control circuit 5a of the bus buffer 5 is brought into ON state. Thus, the bus buffer circuits 5b in the individual data buses are brought into ON state, and the data buses between the microcomputer 4 and the field memory 6 are connected. A H-level signal is inputted to the field memory 6 through its CE (Chip_Enable) terminal, and digital image data can be read from the field memory 6 (active period in FIG. 4). When reading of digital image data is terminated, a H-level signal (5V) is outputted from the microcomputer 4 through its CS1 terminal, and the gate control circuit 5a of the bus buffer 5 is brought into OFF state. Thus, the bus buffer circuits 5b in the individual data buses are brought into OFF state, and the data buses between the microcomputer 4 and the field memory 6 are blocked.

In a case where the main control system power supply 1 is ON and the imaging system power supply 2 is OFF without the bus buffer 5 placed in-between, a problem arises. A current flows from VDD1 to the data buses to the field memory 6, and the elements in the field memory 6 can be destroyed. In a case where the main control system power supply 1 is ON and the imaging system power supply 2 is OFF with the bus buffer 5 placed in-between, the data buses are brought into high impedance state by performing the following operation: a H-level signal is outputted from the microcomputer 4 through its CS1 terminal to bring the gate of the bus buffer 5 into OFF state; the data buses between the microcomputer 4 and the field memory 6 are thereby electrically blocked. As a result, the path from VDD1 to the data buses to the field memory 6 is not formed, and the elements in the field memory 6 are not destroyed.

In this construction, the CS1 signal used to read data from the field memory 6 is also used to control the gate circuit 5a of the bus buffer 5. Thus, the data buses are kept in blocked state, that is, high impedance state on other occasions than when data is read from the field memory 6. Therefore, the data buses can be brought into high impedance state without providing a dedicated circuit. The foregoing applies to cases where the intrusion sensor 103 detects intrusion of the human body of a suspicious individual or the like.

In this embodiment, as described above, the video recorder 7 is brought into the wake-up state only when the camera 101 picks up an image, and is brought into the sleep state after it transfers image data to the field memory 6. Therefore, the duration for which it operates in the wake-up state is short. As a result, the power consumption can be reduced. The image data transferred to the field memory 6 is transferred from the field memory 6 to the image data work memory 10. The adjustment of image size and compression of the image data are carried out in the image data work memory 10. The image data work memory 10 is supplied with power from the main control system power supply 1 separate from the imaging system power supply 2 that supplies power to the video recorder 7 and the field memory 6. Therefore, even after the video recorder 7 and the field memory 6 are brought into sleep state, the image data work memory can operate.

In this embodiment, the imaging system power supply 2 is brought into ON state while a theft detection signal is ON. Therefore, when a human body intrudes into the vehicle, voltage has been already supplied to the camera 101, and the camera 101 can pick up an image without delay.

Although the imaging device for vehicles is described in the above embodiment, the foregoing is strictly for the purpose of illustration, and the imaging device is not limited to the embodiment and various modifications can be made thereto.

What is claimed is:

1. An imaging device mounted in a vehicle, comprising:
an image processing section for processing data of an image picked up by an image recording device including a video camera;
a main control section for performing predetermined processing based on contents of the image data;
a main control system power supply that supplies power to the main control section;
an imaging system power supply that is provided separately from the main control system power supply, and supplies power to the image recording device and the image processing section;
an approach detecting means that detects approach of a human body to the vehicle;
an intrusion detecting means that detects intrusion of the human body into the vehicle; and
a determining means that, when approach of the human body to the vehicle is detected by the approach detecting means, determines that conditions for turning on the imaging system power supply are met,
wherein the main control section performs operations of:
controlling ON/OFF state of the imaging system power supply;
bringing the imaging system power supply into ON state when it is determined by the determining means that the conditions for turning on the imaging system power supply have been met; and
when the imaging system power supply is ON and intrusion of a human body into the vehicle is detected by the intrusion detecting means, generating an image pickup trigger signal, and causing the image recording device and the image processing section to transition from a sleep state which is a low-power consumption state, to a wake-up state, which lasts for a first predetermined time, and
wherein the image recording device, when brought into the wake-up state, picks up an image.

2. The imaging device for vehicles according to claim 1, wherein, when it is determined that the conditions for turning on the imaging system power supply have been met, the main control section switches the state of the imaging system power supply from the OFF state to the ON state, and generates the image pickup trigger signal to bring the image recording device and the image processing section into the wake-up state, which lasts for a second predetermined time.

3. The imaging device for vehicles according to claim 1, further comprising:
an image processing end detecting means that detects that processing by the image processing section has terminated,
wherein, when it is detected that processing by the image processing section has terminated, the main control section brings the image recording device and the image processing section into a sleep state.

4. The imaging device for vehicles according to claim 3, further comprising:
a bus buffer that connects and disconnects signal lines through which the image data is transmitted from the image processing section to the main control section,
wherein, when it is detected by the image processing end detecting means that processing by the image processing section has terminated, the main control section causes the bus buffer to disconnect the signal lines.

5. The imaging device for vehicles according to claim 2, wherein the first predetermined time is shorter than the second predetermined time.

6. An imaging method mounted in a vehicle, comprising the steps of:
monitoring presence or absence of a predetermined action prior to intrusion into a vehicle;
bringing a power supply for an imaging system including an image pickup camera into a sleep state which is a low-power consumption state when the predetermined action is detected;
monitoring the presence or absence of intrusion of a human body into the vehicle; and
when the intrusion of the human body is detected in the sleep state, generating an image pickup trigger signal to bring an image pickup camera and an image processing section into a wake-up state, which lasts for a predetermined time, and picking up the image with the image pickup camera.
